(19) United States
(12) Patent Application Publication
(10) Pub. No.: US 2001/0037591 A1
(43) Pub. Date: Nov. 8, 2001

(54) Outdoor sign with sealed sign module

(76) Inventors: Timothy J. Nicholson, Shoreview, MN (US); John P. Nicholson, Shoreview, MN (US); Gordon M. Melby, Blaine, MN (US); Steve J. McHenry, Inver Grove Heights, MN (US); Paul C. Freeberg, South St. Paul, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 09/766,545

(22) Filed: Jan. 19, 2001

Related U.S. Application Data
(63) Continuation-in-part of application No. 09/716,811, filed on Nov. 20, 2000.
Application No. 09/716,811 is a continuation-in-part of application No. 09/141,007, filed on Aug. 26, 1998, now Pat. No. 6,150,996.
Application No. 09/141,007 is a continuation-in-part of application No. 08/833,945, filed on Apr. 14, 1997, now Pat. No. 6,175,342.
Application No. 08/833,945 is a continuation-in-part of application No. 08/634,031, filed on Apr. 15, 1996, now Pat. No. 5,914,698.
(63) Continuation-in-part of application No. 09/139,897, filed on Aug. 26, 1998, now abandoned.

(51) Int. Cl. G09F 3/04

(52) U.S. Cl. 40/452

(57) ABSTRACT

In a preferred embodiment of the invention, an outdoor sign has a plurality of display modules, each hermetically sealed, for forming a hermetically sealed large sign screen. Each module is preferably formed of a lightweight plastic enclosure with an open interior containing circuitry and light emitting diodes. Means for minimizing deflection of the front panel are incorporated into the enclosure. One such means includes a single restrictive vent for pressure equalization to minimize deflection of the face portion. The means also includes an internal diaphragm to maintain the integrity of the hermetic seal. A feature and advantage of the invention is that moisture and other containments are effectively precluded from entry into the chamber containing the circuitry and LED's of the display sign.

This is a continuation-in-part of U.S. patent application Ser. No. 09/716,811 filed Nov. 20, 2000, which was a continuation-in-part of application Ser. No. 09/141,007 filed Aug. 26, 1998, which issued as U.S. Pat. No. 6,150,996 on Nov. 21, 2000, which was a continuation-in-part of application Ser. No. 08/833,945, filed Apr. 14, 1997, now U.S. Pat. No. 6,175,342, which was a continuation-in-part of application Ser. No. 08/634,031 filed Apr. 15, 1996, now U.S. Pat. No. 5,914,698, issued Jun. 22, 1999. This application is also a continuation-in-part application of U.S. Ser. No. 09/139,897, filed on Aug. 26, 1998. All of the above patents and their respective applications are incorporated herein by reference.

### BACKGROUND OF THE INVENTION

The present invention relates to apparatus and methods relating to signs suitable for outdoor use and with electrically changeable message screens. More particularly, the invention relates to signs suitable for roadside and for providing messages viewable and readable at a distance of at least 200 feet.

Prior art changeable message signs with field electronically changeable messages suitable for roadside use have been cumbersome and expensive due to the conventional methods of constructing the signs which were necessary for operation outdoors where the sign is subject to the elements, namely, wide variations in temperatures, glaring sunlight, rain, sleet, snow, wind, debris, salt and other factors detrimental to large scale electronic devices.

Such signs conventionally utilize a single large sign enclosure for framing and containing a matrix of changeable pixels which form the screen that displays the changeable message. The protection of the pixels, which are typically LED's and/or mechanically flipped fluorescent panels, as well as associate circuitry, is typically provided by the single large screen enclosure and an integral and unitary screen panel that is transparent or has transparent portions and which covers the entire screen. In the prior art signs the screen enclosure defines and limits the size of the message screen.

The circuitry for driving the pixels in these prior art signs is hardwired in a generally permanent fashion within the sign enclosure. In portable signs the access door typically includes the screen panel which is swung upwardly and propped open for working on the circuitry and/or pixels.

The prior art signs utilizing LED's and/or flip panels as the pixels were typically constructed of a number of individual circuit boards with the LED's extending therefrom. The circuit boards are arranged in the desired message screen shape and size within the rigid steel sign enclosure. Typically, the sign controller will either connect independently through multiple conductors from the sign controller to each circuit board and associate LED's or there will be multiple ribbon cable and associated LED's or there will be multiple data lines in a daisy chain arrangement to each circuit board.

The sign enclosures are specifically sized for the desired message screen size. A sign controller, either within the screen enclosure or separately enclosed, operates to control the changeable message. Each of the circuit boards is assigned an address and the sign controller will typically utilize ribbon cable and connects with multiple data conductors to send parallel data to the individual circuit boards for displaying the desired message. See U.S. Pat. No. 4,197,527 to Romney which discloses an outdoor modular sign. As in other prior art signs, Romney discloses the use of extensive cabling and wire harnesses for connecting to and providing control signals to the modules. Moreover, the modules in Romney, as in any other art outdoor signs utilizing modular circuit board arrangement of which the applicants are aware, are enclosed in an unsealed sign screen enclosure with the nonexpendable and nonreconfigurable sign screen. The support and mounting structure for the modules are thus sized for and are typically part of such sign enclosures. Moreover any such mounting structure will typically provide only mechanical support for the mounting of the modules. Electrical connections are accomplished separately from the mechanical attachment to the sign enclosure and such electrical connections provide no mechanical support for the module.

As a result of the configurations of conventional prior art exterior changeable message signs, the pixel elements and the circuitry for the pixels are not serviceable from the front of the sign screen. Moreover, typically such prior art signs are not user serviceable and where such service is performed, the sign screen enclosure must be entered or opened thereby exposing all internal circuitry and pixel elements to the weather. This can cause difficultly in field servicing the sign screens particularly during rain or snow showers.

Much, if not the majority of the weight and bulk of traditional outdoor changeable message signs is in the screen enclosure. A breach of the enclosure, such as a crack or hole in the transparent screen panel subjects the entire screen circuitry and pixels to the elements, particularly moisture. Moreover, the size and weight of the screens necessitate heavy machinery, for example a crane, to install such signs.

Moreover, due to the massive weight, principally from the enclosure, dropping the changeable message screens can cause extensive damage to the sign screen or other property. Also, the significant bulk, weight, and rigid metal structure presents a hazard to personnel during the installation of such signs and to motorists who might collide with same.

Moreover, the weight and bulk of traditional outdoor changeable message signs requires a large and expensive support structure to support the enclosure. This of course increases the cost and labor for transportation and erection of such signs.

Changeable outdoor message signs typically utilize light emitting diodes (LED's) as pixels in the matrix to provide changeable messages. Such diodes can generate substantial amounts of heat. Additionally these changeable message signs are used outdoors and are thus exposed to the elements including direct sunlight, rain, and snow. It is critical that these outdoor signs which often warn of hazardous conditions must remain operational in varying conditions with minimal maintenance. The outdoor highway signs typically have message screens which are in the range of six by ten feet or even greater. Signs of such size utilize numerous LED's and also thus have much transparent screen surface area exposed to the sun, both factors can cause rapid heating of the interior of the message sign. Moreover, moisture such as from rain, snow, sleet and the like is inimical to the electronics and other internal components of these highway message signs. Therefore, ideally these message signs would be sealed from the elements. However, such sealing can trap heat within the screen enclosure, and were hermetically sealed, can create significant pressure differentials between the interior and exterior which can cause failures or distortion of the screen enclosure.

Handling the heat from the LED's and the sun within such sign enclosures has been dealt with in the past by way of fans and other types of air conditioning equipment. This of course, increases the weight, complexity maintenance issues, and cost of the signs. Moreover, due to the size of the enclosures, effective weatherproofing was difficult and effective economic hermetic sealing of such enclosures may generally be considered impossible. Typically large sign enclosures will simply have water drains in the bottom of said to eliminate the inevitable accumulation of water in the interior of said containers.

LED's have been embedded in epoxies with circuitry also sealed in control panel type application where the characters are viewable from a few feet. These types of designs are not workable for large exterior signage due to the added cost and difficulty of manufacture as well as the added weight and difficulty in repair or replacement of individual LED's.

### SUMMARY OF THE INVENTION

In a preferred embodiment of the invention an outdoor electronically changeable message sign is comprised of a plurality of exteriorly exposed coplanarly positioned display modules with the display modules forming the sign screen. In the preferred embodiment each display module comprises a lightweight plastic enclosure with an open interior containing circuitry and light emitting diodes and is hermetically sealed from exterior elements. Means for minimizing deflection of the front panel are incorporated into the enclosure. One such means includes a single restrictive vent or conduit for pressure equalization to minimize deflection of the face portion. The means also includes an internal diaphragm across said conduit to maintain the integrity of the hermetic seal.

A feature and advantage of the invention is that moisture and other containments are precluded from entry into the chamber containing the circuitry and LED's of the display sign.

A feature and advantage of the invention is that use of the individually sealed sign modules to form the sign screen provides a reliable, robust, lightweight large screen electronically changeable message sign for use outdoors in the elements.

A further feature and advantage of the invention is that the use of exteriorly exposed modules facilitates individual replacement of the modules as well as permitting field reconfiguration of the sign screen and field construction of signs.

An additional advantage of the invention is that solar heating of each sign module through the front screen portion does not deflect the screen due to pressure build-up. In preferred embodiments the diaphragm operates to equalize pressure differential created by the internal heating of the sign enclosure. The diaphragm also compensates for internal heating of the sign by the LED's while maintaining the hermetic seal.

An additional advantage and feature of the invention is that the second chamber which is vented to the exterior of the sign module is defined by a protruding structure on the module. Said protruding structure which provides structural strength to the module enclosure and also provides structure for engagement with the mounting track portion of the support structures.

### BRIEF DESCRIPTION OF THE DRAWINGS

FIGS. 1-4 are perspective views of outdoor electronically changeable message sign incorporating the invention.

FIG. 5 is a perspective view of a mobile electronically changeable message sign showing the backside of the sign screen.

FIG. 6 is a perspective view of the front of a display module in accordance with the invention herein.

FIG. 7 is a perspective view of the backside of the display module of FIG. 6.

FIG. 8 is a cross-sectional view of attachment means and electrical connector means for a display module.

FIG. 9 is an exploded view of a display module incorporating the invention.

FIG. 10 is a rear elevational view of a display module incorporating the invention.

FIG. 11 is a cross-sectional view taken at line 11-11 of FIG. 10.

FIG. 12 is the same view of FIG. 4 showing an alternative embodiment of the invention.

FIG. 13 is a sectional view through a display module showing a reinforced front display panel.

FIG. 14 is a sectional view through line 14-14 of FIG. 13.

### DETAILED DESCRIPTION OF PREFERRED EMBODIMENTS

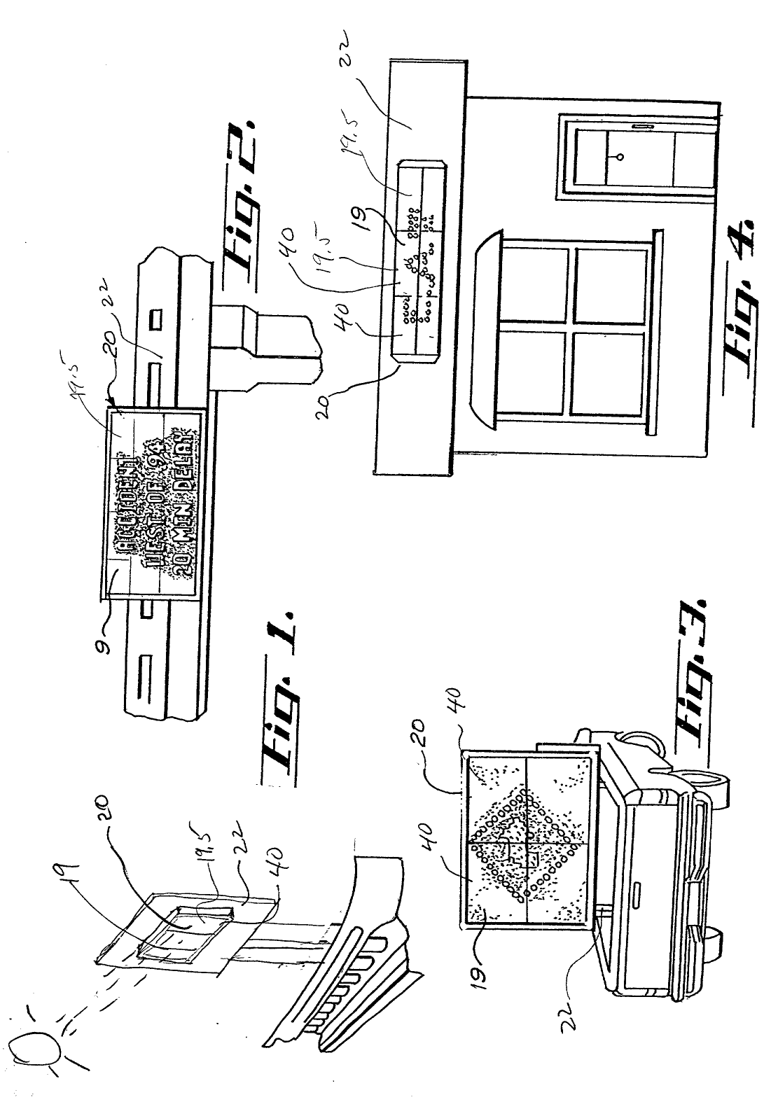

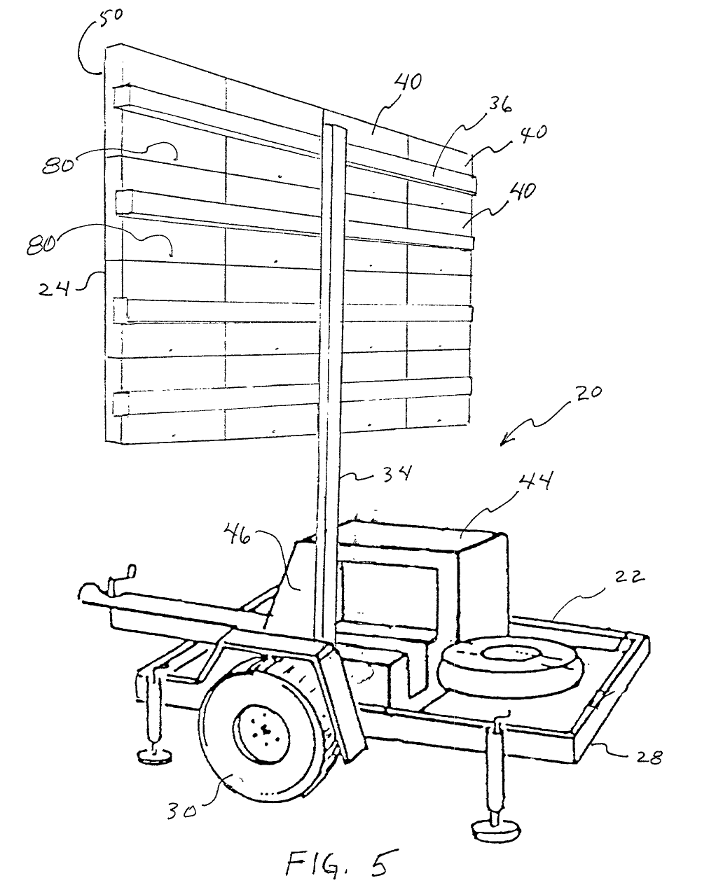

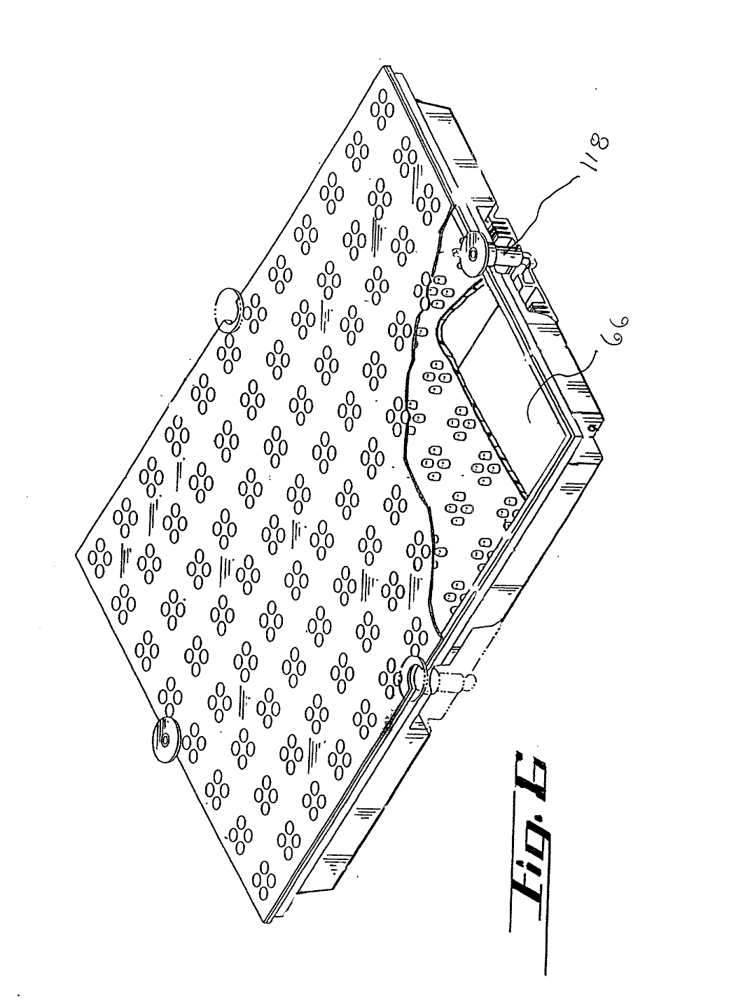

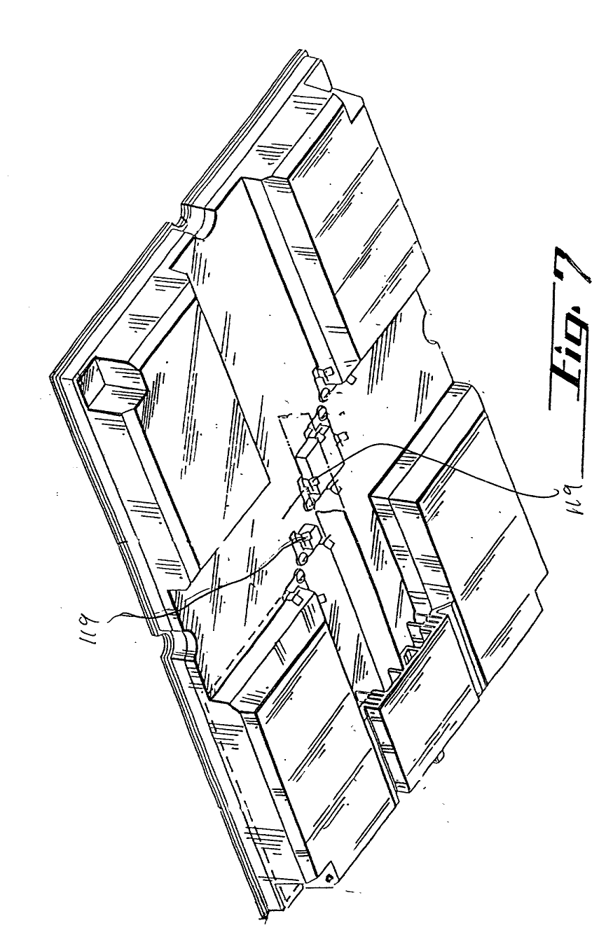

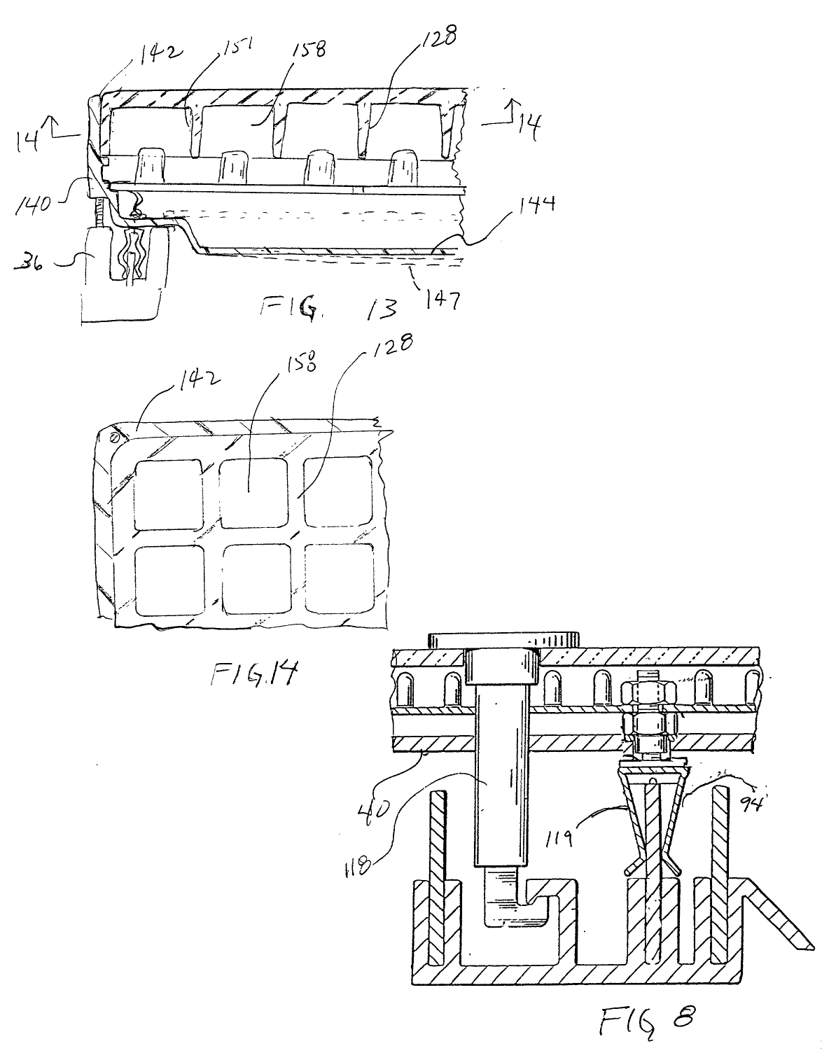

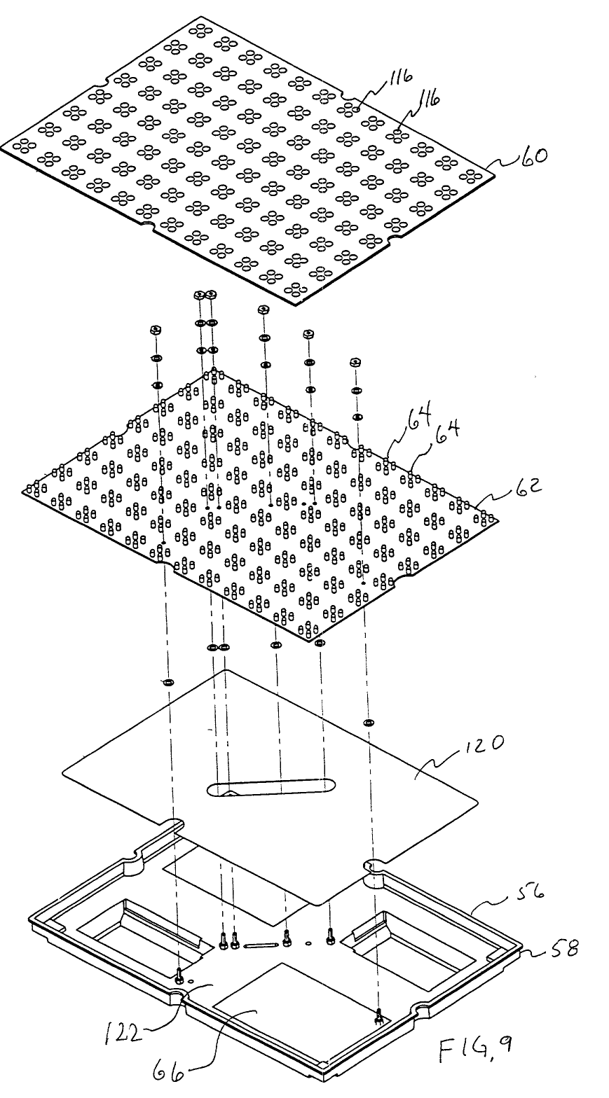

Referring to FIGS. 1-4, various configurations of signs 20 according to the invention in various applications are illustrated. Each of said signs have a sign screen 19 defined by the screen portions 19.5 of individual adjacent display modules 40 and utilize a support structure 22. Such support structure may be a building, an existing highway sign a structure on a truck, or other movable or nonmovable structure.

Referring to FIG. 5 an electronically changeable outdoor modular message sign is shown and is generally designated with the numeral 20. The outdoor sign principally comprises a support structure 22 and a message screen 24. The support structure consists of a trailer 28 with ground engaging wheels 30, a standard 34 and support tracks 36. The standard 34 is typically articulated such that the screen 24 may be raised and lowered for transportation or adjusted for optimal visibility to viewers. The sign screen is comprised of a plurality of display modules 40 which are interchangeable and are configured to be positioned adjacent to one another such as in the rectangular matrix pattern as shown. The display sign also includes a power supply 44 and a control unit 46 for powering and controlling the modular display signs. The power supply may be an electric generator or batteries or rechargeable batteries with solar power assist, all of which are known in the art. The control unit 46 is programmable to provide any desired variable message. The control units work in conjunction with the individual display modules to initiate addressing of each of the individual display modules and transferring an appropriate bit map to each of the display modules whereby a message is displayed on the display side 50 of the screen 24.

Referring to FIGS. 6-14, details are shown of display modules in accordance with the invention. Details of such display modules are further disclosed in U.S. Pat. Nos. 5,914,698 and 6,150,996 which are incorporated herein by reference. Each display module is principally comprised of a generally rigid plastic enclosure 56 formed of a base portion 58 configured as a tray. A transparent front face portion 60, a circuit board 62 with pixel elements 64 which in the preferred embodiment are light emitting elements such as LED's, and a diaphragm configured, for example, as a flexible membrane 66. The flexible membrane may be made of latex which is suitable for the configuration as shown in FIGS. 9 and 11. The membrane in such a case is elastomeric providing flexibility and resiliency. Additionally, the membrane may be configured as an inflatable bellows 66 which can either be relatively non-expandable, formed of such materials as PVC, or can again be formed of expandable materials, such as latex, to allow expansion.

The diaphragm or flexible membrane 66 extends across a conduit 69 defining within the open interior 68 of the enclosure, a first chamber 70, and a second chamber 72. In the embodiment of FIG. 11 the second chamber is also defined by the structural protruding portion 76 which has an inside surface 78 which forms a part of the periphery of the second chamber. The second chamber has a restrictive vent 80 which extends to the exterior 82 of the display module enclosure 56. The vent may be supplementally shielded by way of additional filters or screens indicated by the dashed structure 86 of FIG. 11. Known filters or screens such as fiber material, or carbon granules or sintered beads, plastic or metal, would be suitable. Such supplemental filter member can provide primary or secondary isolation of the circuitry and LED's.

Referring specifically to FIG. 12, an alternative embodiment of the diaphragm is shown whereby the second chamber is defined exclusively by the interior surface 86 of the flexible membrane configured as a bellows.

The structural protruding portion 76 of the display module 40 serves to provide additional structural rigidity to the enclosure 56 as well as providing the recess 90 in the interior of the enclosure for defining the second chamber as in FIG. 11 or for providing a suitable location for a bellows as in FIG. 12. The support track 36 is sized to engage within two or more of the structural protruding portions 76 as shown in FIG. 10. Electrical connections can be made by way of mechanical electrical connectors 94 on the display module that connect to conductors 96 in the support such as disclosed in the companion applications discussed above or may otherwise by connected through other electrical connector means such as cabling or male connectors 102 and female connectors 104 for connecting adjacently placed modules as shown in FIG. 10.

The diaphragm may be suitable attached to the inside surface of the enclosure by way of adhesives such as a cyanoacrylate adhesive 106 or can be held in place by way of a suitable mechanical clamp 108. Similarly, the filter element 86 can be attached by way of an cyanoacrylate adhesive or other suitable means.

Typically the transparent front face portion 60 will be a plastic material such as a polycarbonate or other materials known in the art. Paint 112 may be suitably provided to the transparent piece 114 such as by silk screening to form the front face portion. Suitably portions would be left unpainted from the windows 116 as shown in FIGS. 9, 11, and 12.

Referring to FIG. 8, the display modules 40 may utilize various structural removable attachment means 18 and electrical attachment means 119 configured as a clip connector.

As shown in FIG. 9, an additional sheet 120 of latex material may be added intermediate the circuit board 62 and the back panel 122 to provide further moisture protection and some cushioning protection for the circuitry and light emitters.

The transparent front face portion is suitably attached with adhesive and may be supplementally sealed such as a silicon sealant. Ideally the seal will provide a hermetically sealed enclosure with the flexible membrane providing pressure equalization between the first chamber and the second chamber. Such pressure equalization is particularly important in preferred embodiments where the transparent front face portion is made of a thin rigid plastic material, for example, polycarbonate, which can bow significantly if the pressure equalization means are not provided.

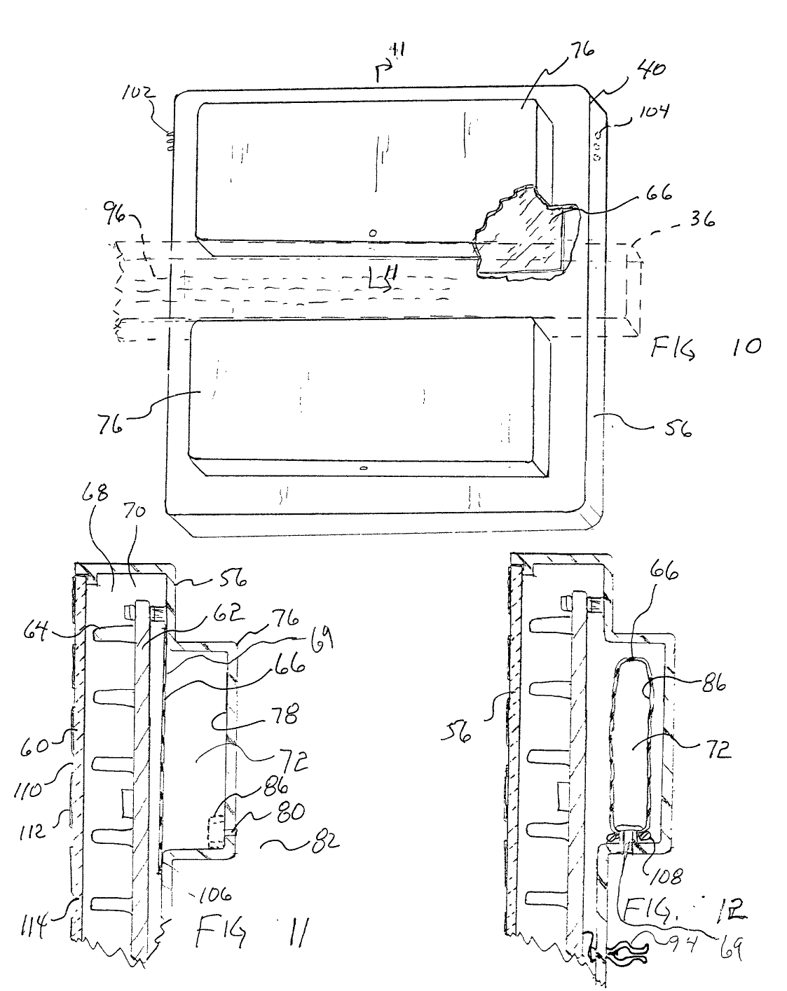

Referring to FIGS. 13 and 14, alternate means for minimizing deflection of the front face portion are shown. The front face portion has additional reinforcing structure 120 to provide rigidity. Additionally, the module is configured such that it attaches to a mounting structure 36 at the enclosure's periphery 142 and the back panel 144 is flexible enough such that it can flex as indicated by the dashed lines 147 thereby relieving the potential buildup of an interior-exterior pressure differential. The back panel is configured to substantially less rigid that the front face portion whereby the back panel flexes rather than having any significant deformation of the front panel. The enclosure is configured such that bowing or flexing of the rear panel does not affect the engagement of the module with the mounting structure nor with the electrical connections.

Opaque material may be added within the individual recesses 158 to minimize light crossover between adjacent pixels.

Thus the means of minimizing the deflection of the front face portion include providing greater rigidity to the front face portion, building in flexibility in portions of the enclosure other than the front face portion and utilizing a diaphragm or billows to divide the open interior into two chambers.

The present invention may be embodied in other specific forms without departing from the spirit of the essential attributes thereof, therefore, the illustrated embodiments should be considered in all respects as illustrative and not restrictive, reference being made to the appended claims rather than to the foregoing description to indicate the scope of the invention.

What is claimed:

1. An outdoor electronically changeable message sign comprising:
a support structure, and
a plurality of sign modules connected to the support structure, the sign modules arranged next to one another defining an upright sign screen with the messages on said sign readable from at least 200 feet, the sign screen adjustable and subject to the elements including sun exposure, each module comprising:
a weather resistant hermetically sealed rigid enclosure comprising a transparent front face configured as a panel, and a base portion, each module having an interior and an exterior, the enclosure having a conduit leading from interior to the exterior the transparent front face of each module subject to sun exposure whereby the interior of the sealed enclosure is heated, said front face deflectable under a pressure differential between the interior and exterior of the enclosure, each module removably attachable to the support structure,
a plurality of heat generating light emitting elements contained in the interior of the enclosure adjacent to said transparent front face, said heat generating light emitting elements also providing heating of interior of the sealed enclosure;
an impervious membrane comprised of a flexible sheet material transversing the conduit thereby isolating the exterior of the module, the membrane moveable in response to varying pressure differentials between the interior and the exterior whereby the pressure in the interior is equalized with the pressure at the exterior of the module and deflection of the front panel due to heating of the interior is eliminated.

2. The outdoor sign of claim 1 wherein the interior is defined by a protruding portion defining a recess, said protruding portion extending outwardly from the base portion and the diaphragm extends across the recess.

3. The outdoor sign of claim 2 wherein the sign further includes means for removably attaching each module to the support structure.

4. The outdoor sign of claim 1 wherein the membrane is configured as a volumetrically expandable sac.

5. The outdoor sign of claim 1 wherein each module further comprises a filter in the conduit.

6. A display module for an electronically changeable message sign, the module comprising:
a hermetically sealed rigid enclosure having an open interior, an exterior, and a planar front panel with an inside surface, the front panel formed of a thin polycarbonate sheet that bows under a pressure differential;
a plurality of pixel elements comprised of light emitting diodes positioned in the open interior adjacent the front panel and viewable therethrough, the light emitting diodes providing heating of the interior of the enclosure; and
a membrane comprised of a flexible sheet material separating the open interior into a first chamber and a second chamber, the front panel forming part of the first chamber, the second chamber vented to the exterior of the sign module, the flexible membrane moveable whereby the pressure in the first chamber is equalized with the pressure in the second chamber thereby preventing bowing of the front panel due to pressure differentials between the interior and exterior of the sealed enclosure from the heating of the enclosure.

7. The display module of claim 6 wherein the enclosure has an outwardly protruding portion defining a recess in the interior of the enclosure, the flexible membrane extending across and covering said recess.

8. The display module of claim 7 wherein the membrane is comprised of a flexible resilient material.

9. The display module of claim 6 further comprising a filter where the second chamber is vented to the exterior.

10. The display module of claim 9, wherein the enclosure is formed from thermoplastic.

11. The display module of claim 11 further comprising means for removably attaching the module to a sign structure and means for electrically connecting the module to a sign controller.

12. An outdoor changeable message sign comprising:
a support structure;
a plurality of weather resistant hermetically sealed enclosures, each comprising a front face portion with at least one transparent portion, the front face portion sized to be at least one square feet in area and a base portion;
a plurality of pixel elements electronically changeable for changing messages, contained within the enclosure adjacent to said transparent front face portion; and
means for minimizing deflection of the transparent face portion, said means comprising means for providing pressure equalization between the interior and exterior.

13. The outdoor sign of claim 12, wherein the sealed enclosure is comprised principally of thermoplastic.

14. The outdoor sign of claim 13 wherein the front face is comprised of a polycarbonate.

15. A changeable message sign with an adjustable screen size, the sign comprising:
a plurality of interchangeable sealed display modules positioned in a matrix arrangement having a rectangular periphery, each display module comprising:
a front display side with a height of at least six inches and a width of at least six inches, the front display side defining an exteriorly exposed screen portion, the screen portions of the plurality of display modules defining an exteriorly exposed sign screen, whereby the screen portions of each of the modules are not positioned behind a screen panel;
an array of pixel elements positioned at the screen portion of each of said modules, the pixel elements sufficient in number to define at least one complete alphanumeric character within each of said screen portions;
circuitry contained within the module and connected to the pixel elements for operating the pixel elements;
a means for equalizing the pressure in the module with the pressure exterior the module;
a support structure with a front side and a back side, the matrix arrangement of modules supported by said support structure on said front side, said modules configured such that each individual module is removable and replaceable without opening a sign enclosure;
a sign controller comprised of circuitry and configured for communicating with each of the display modules in the sign controller further configured for allowing additional display modules to be added to the matrix, and wherein the sign modules are of sufficient size to be readable from at least 150 feet in front of the sign.

16. A method for constructing changeable message signs, said method comprising the steps of:
selecting a desired number of interchangeable modules for a desired screen size, each module comprising a weatherized enclosure, a screen portion, a plurality of changeable pixel elements in the enclosure, a diaphragm operatively positioned between the interior and exterior of the module for equalizing pressure therein, circuitry for operating the pixel elements in the enclosure and an electrical connector connecting to the circuitry, said connector fixed with respect to the enclosure; and
removably installing the modules in a matrix arrangement on a support structure;
connecting the modules to a sign controller for operating said modules.

17. A method of manufacturing outdoor highway signs readable at a distance of at least 200 feet with a hermetically sealed sign screen, the method comprising the steps of:
providing a plurality of display modules, each with a viewable screen at least six inches in height and six inches in width, a mounting structure, and a sign controller;
hermetically sealing each sign module including installing a diaphragm in a conduit extending between the interior of each module and the exterior of each module, thereby providing pressure equalization while maintaining the hermetic seal;
assembling the display modules on a mounting with each display module exteriorly exposed;
putting each display module in communication with the sign; and
addressing each display module with respect to its position on the mounting structure.
